(19) United States
(12) Patent Application Publication
(10) Pub. No.: US 2018/0075373 A1
(43) Pub. Date: Mar. 15, 2018

(54) SYSTEM AND METHOD FOR A CARE SERVICES MARKETPLACE

(71) Applicant: 911CARE LLC, Chagrin Falls, OH (US)

(72) Inventor: Nicole Dominica Paolozzi, Chagrin Falls, OH (US)

(73) Assignee: 911CARE LLC, Chagrin Falls, OH (US)

(21) Appl. No.: 15/705,795

(22) Filed: Sep. 15, 2017

Related U.S. Application Data
(60) Provisional application No. 62/395,355, filed on Sep. 15, 2016.

(51) Int. Cl. G06Q 10/06; G06Q 30/06; G06Q 30/02

(52) U.S. Cl. CPC G06Q 10/06; G06Q 30/0206; G06Q 10/06311; G06Q 30/0601

(57) ABSTRACT

Computerized system and methods for arranging and overseeing the provision of care services between care clients and care resources so as to form a care services marketplace. The system and method utilize a plurality of care resource devices and a plurality of care client devices that communicate over one or more networks. An automated method matches a care client with care resources based on core commonalities and then sorts the matches into different categories using a set of rules applied to the parties' preferences. The sorted matches are provided to the care client, who may select one of the care resources for the provision of services. A selected care resource is notified and may agree to provide services to the care client. Once the care resource has performed the services and the care client approves payment, reviews are collected and the care resource is automatically paid through a payment gateway.

### CROSS-REFERENCE TO RELATED APPLICATION(S)

This application claims priority under 35 U.S.C. § 119(e) to: U.S. Provisional Patent Application No. 62/395,355, filed on Sep. 15, 2016, which is herein incorporated by reference.

### BACKGROUND

The present disclosure relates to a system and method for facilitating service transactions between service providers and purchasers, and more particularly to a system and method for providing an on-line peer-to-peer marketplace for care services.

Systems and methods exist for facilitating service transactions either on-line or off-line. However, most of these systems and methods are not truly peer-to-peer. Typically, they are focused on the purchaser, i.e., they are provided for the benefit of and as a service to the purchaser, and only incidentally provide a benefit to the provider. In addition, conventional service facilitating systems and methods typically do not oversee a transaction from formation through completion and help guide the parties through the entire process. Furthermore, the care provider selection process is typically confined to providing a care purchaser with a list of candidates that meet a limited set of predetermined criteria. Little, if any, other analysis is provided to the care purchaser, which can be frustrating if the list of qualified candidates is lengthy and unwieldy. Finally, conventional systems gather and analyze only a limited amount of data about the transactions they facilitate. To the extent such collection and analysis happens at all, the results are typically not provided to participants in the system in an easy-to-comprehend and user-friendly manner.

### SUMMARY

The present disclosure is directed to a method for arranging and overseeing the provision of care services between care clients and care resources in a peer-to-peer services marketplace computer system. In accordance with the method, a profile database is provided, which stores information about the care clients and the care resources. The information stored about the care resources includes availability, services being offered, geographic service area, experience, offered fee ranges and ratings. The information stored about the care clients includes preferences for care resources. The preferences include preferred fee rates, preferred experience and preferred ratings.

Also in accordance with the method, a care service request message is received from a care client via a first communication device. The care service request message includes a description of a requested service, a date and time period for performance of the requested service and a location where the requested service is to be performed. The preferences of the care client are retrieved from the profile database. A job specification is created from the care service request message and the retrieved preferences of the care client. The job specification includes the care client's preferred fee rate, the care client's preferred experience and the care client's preferred rating. Information about care resources is retrieved from the profile database. The job specification is compared with the retrieved information about care resources to identify care resources who meet predetermined minimum requirements of the job specification.

Rules are applied to the job specification and the retrieved information for the identified care resources to sort the identified care resources into categories comprising exact match, upsell match, substitution match and discount match. The rules for the exact match category as applied to each identified care resource require that the offered fee range of the identified care resource includes the care client's preferred fee rate, the experience of the identified care resource matches the care client's preferred experience and the rating of the identified care resource is at or above the care client's preferred rating. The rules for the upsell match category as applied to each identified care resource require that the offered fee range of the identified care resource is above the care client's preferred fee rate, the experience of the identified care resource matches the care client's preferred experience and the rating of the identified care resource is at or above the care client's preferred rating. The rules for the substitution match category as applied to each identified care resource require that the offered fee range of the identified care resource includes the care client's preferred fee rate, the experience of the identified care resource does not match the care client's preferred experience and the rating of the identified care resource is at or above the care client's preferred rating. The rules for the discount match category as applied to each identified care resource require that the offered fee range of the identified care resource is below the care client's preferred fee rate and one or both of: the experience of the identified care resource does not match the care client's preferred experience and the rating of the identified care resource is below the care client's preferred rating.

A message containing the sorted identified care resources is transmitted to the first communication device. In response, a selection message is received from the first communication device, indicating a selection of one of the sorted identified care resources. An offer message is sent to a second communication device of the selected care resource. In response, an acceptance message is received from the second communication device of the selected care resource. A notification-of-acceptance message is then sent to the first communication device.

### BRIEF DESCRIPTION OF THE DRAWINGS

The features, aspects, and advantages of the present disclosure will become better understood with regard to the following description, appended claims, and accompanying drawings where:

FIG. 1 shows a schematic view of a portion of a system for creating a sharing community;

FIG. 2 shows a first schematic of a matching and sorting method that may be performed by the system of FIG. 1;

FIG. 3 shows a second schematic of the matching and sorting method that may be performed by the system of FIG. 1;

FIG. 4 shows a schematic of a process for registering new care clients and new care resources with the system of FIG. 1;

FIG. 5 shows a schematic of a method for arranging care services between parties immediately/on-demand;

FIG. 6 shows a schematic of a method for arranging care services between parties to be scheduled in the future;

FIG. 7 shows a schematic view of additional portions of the system of FIG. 1;

FIG. 8 shows a care resource profile panel of a graphical user interface (GUI) of a care resource device;

FIG. 9 shows a care resource control panel of the GUI of the care resource device;

FIG. 10 shows a care resource preference panel of the GUI of the care resource device;

FIG. 11 shows a care resource feedback panel of the GUI of the care resource device;

FIG. 12 shows a care client profile panel of a GUI of a care client device;

FIG. 13 show a job profile panel of the GUI of the care client device;

FIG. 14 shows a care client feedback panel of the GUI of the care client device; and

FIG. 15 shows a care client payment panel of the GUI of the care client device.

### DETAILED DESCRIPTION OF ILLUSTRATIVE EMBODIMENTS

It should be noted that in the detailed description that follows, identical components have the same reference numerals, regardless of whether they are shown in different embodiments of the present disclosure. It should also be noted that for purposes of clarity and conciseness, the drawings may not necessarily be to scale and certain features of the disclosure may be shown in somewhat schematic form.

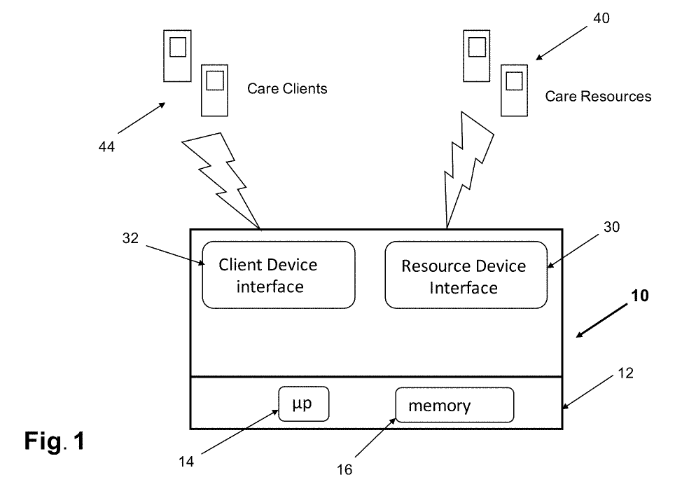

Referring now to FIG. 1, a peer-to-peer marketplace system 10 is provided for creating a service marketplace or sharing community in which the provision and consumption of care service is facilitated through programmable devices, based on the matching of profiles that are input by both care resources and care clients. Generally, the system 10 includes a platform 12 having one or more processors 14, memory 16 and one or more interface devices (not shown), including one or more network interfaces and one or more storage interfaces. The memory 16 includes dynamic storage memory, such as random access memory (RAM), for storing information and instructions to be executed by the one or more processors 14. The memory 16 also includes static storage memory, such as read-only memory (ROM) for storing static information and instructions for the one or more processors 14. When executed by the one or more processors 14, the instructions stored in memory 16 perform the methods described herein.

The system 10 also includes a resource device interface 30 and a client device interface 32. The system 10 communicates over one or more networks with a plurality of care resource devices 40 and a plurality of care client devices 44 using the resource device interface 30 and the client device interface 32, respectively. The networks may include one or more wired and/or wireless networks. For example, the networks may include a cellular network, a local area network (“LAN”), a wide area network (“WAN”), a wireless wide area network (WWAN), a metropolitan area network (“MAN”), a telephone network (e.g., the Public Switched Telephone Network), an intranet, the Internet, a fiber optic-based network, and/or a combination of these or other types of networks.

The system 10 may comprise one or more dedicated host machines (local or remote) and software providing the various servers, databases, data stores, and the like, necessary to perform the methods and provide the services described herein. Alternatively, the system 10 may comprise a service provider environment such as cloud infrastructure, platform, and/or software providing the various resources (e.g., server, database, data store, and the like) necessary to perform the methods and provide the services described herein.

Each care resource device 40 and each care client device 44 is microprocessor-based and runs a service software application that enables the device to communicate with the system 10 through the resource device interface 30 or the client device interface 32, as the case may be. The care resource devices 40 and the care client devices 44 may be laptop computers, desktop computers, cellular phones or smartphones, tablet devices or any other microprocessor-based communication devices. In each care resource device 40 and care client device 44, the service application generates a graphical user interface that displays information to a user and through which information may be received from a user.

The care resource devices 40 and the care client devices 44 each have a location tracking feature. The location tracking feature may be the IP address of the device, cell tower-based information and/or a GPS receiver. In addition to any or all of the foregoing, the location tracking feature may include a geolocation software application running on the device. The geolocation application may permit the system 10 to track the location of the care resource device 40 or the care client device 44, as the case may be, using the location provided by the GPS receiver or otherwise.

In order for a care client or a care resource (generically a “user”) to communicate with the system 10, the user must log-in to the system 10 through the graphical user interface of their care resource device 40 or care client device 44, as the case may be, using a unique username and password, which is assigned to the user during a registration method, described more fully below. Through the log-in process, the system 10 obtains the current location of the user.

The care resource devices 40 are used by care resources, who typically specialize in providing one or more types of services. The system 10 is particularly suited for services involving personal interaction, such as healthcare, childcare, eldercare, personal training and fitness, hair styling and barber services, counseling, physical therapy and occupational therapy. However, the system 10 may also be used for other services, such as home and auto repair, plumbing, electrical, lawn and garden services, moving and delivery services, errand services, culinary services, catering services and veterinary services. The services may be provided at the home of a care client, at the place of business of the care resource, or at any other location. The care client devices 44 are used by anyone who needs to have services performed for them. Indeed, a person may at one time be a care resource and at another time may be a care client.

The care services may be immediate (i.e., on-demand) or in the future (i.e., scheduled). The system 10 may provide matching parameters around personal preferences, education, and/or job history. In addition to or in lieu of these matching parameters, the system 10 may provide matching parameters around pay ranges and/or distance between parties. Further, the system 10 may obtain authorization to execute one or more background or criminal checks and display relevant check information to community members for the purposes of transparency for everyone within the community. The system 10 may also obtain authorization to make and/or receive payment and collect relevant payment vehicle and/or bank account information to interface with a predetermined payment system. The system 10 may also obtain authorization to receive geo-location information from care resource devices 40 and/or care client devices 44.

The system 10 may compare compiled employment, criminal, and other checks (collectively a “background check”) of a party to a set of predetermined vetting parameters to generate a background scorecard for the purposes of determining inclusion in or suspension from the sharing community. The background scorecard for all approved applicants, as well as all rejected applicants, may be provided to the members of the sharing community.

The system 10 performs a matching and sorting method for quickly enabling care services to be arranged between parties using the care resource devices 40 and the care client devices 44. Using a care client device 44, a care client can transmit a request for care from a given care client geographic location or for a predetermined location. The system 10 may handle the request by selecting a care resource or providing a list of care resources that meet criteria to provide care to the care client. The matching of care resource(s) to a care client requesting the care may be performed based on parameters such as: the type of service, the date and time the service is to be provided, the location of the parties, the availability of the care resource, care resource experience, care resource preferences, care client preferences, ratings, pay rates and ranges, and different combinations of any of the foregoing. Care resource preferences may include preferred pay rate or range, care client rating, number of jobs the care client has purchased from the sharing community, payment history and the number of common friends the care resource has on social media (e.g., Facebook). Care Client preferences may include preferred pay rate or range, care resource rating, the experience of the care resource, the number of jobs the care resource has performed for the sharing community and number of common friends on social media (e.g., Facebook). The experience of the care resource may include education, work history, training, certifications, licenses, awards and commendations.

The sorting and visualization of the care resource options may be transmitted automatically to a care client device 44. The care client can quickly review the matching care resource options and may offer the job to a specific care resource within the matched and sorted list. In response, the selected care resource may accept the assignment. The system 10 may track the location and distance between parties before and during the assignment and store it in memory 16. In addition, the system 10 may provide this information to both contracted parties.

Once a care resource has finished the assignment, the system 10 may automatically, or upon request of the care client, effect the payment for the care service, as described more fully below. In addition, the system 10 may solicit and receive feedback from both the care resource and the care client. This feedback may be used to rate both parties. The feedback and ratings may be made available to both the care resource and the care client, as well as other members of the sharing community. The feedback, ratings and details of the care assignment are all stored in the memory 16 and may be used with other historical data of the parties to update their profiles and cumulative ratings, respectively. In this manner, the system 10 improves the future decision-making of all members of the sharing community.

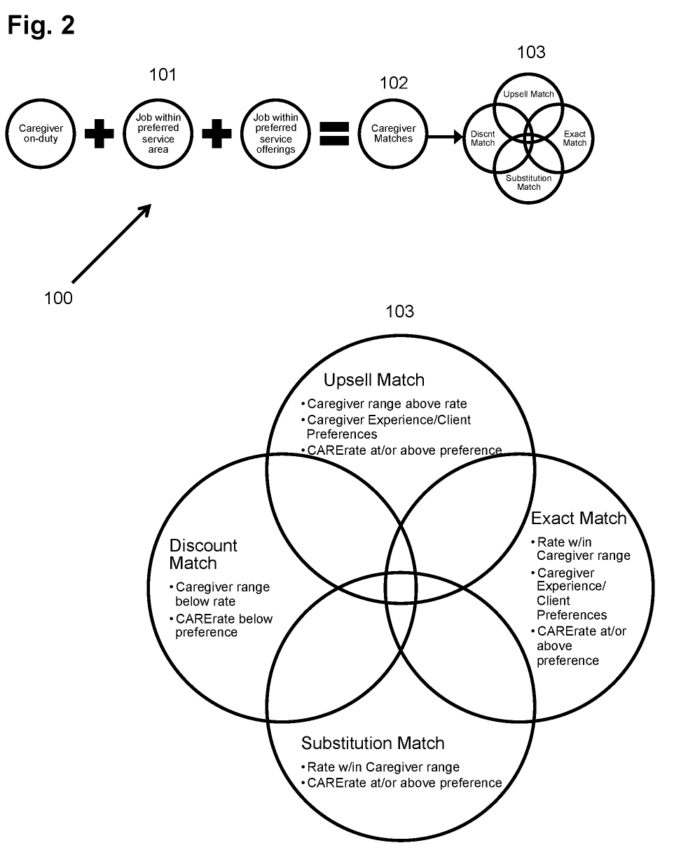

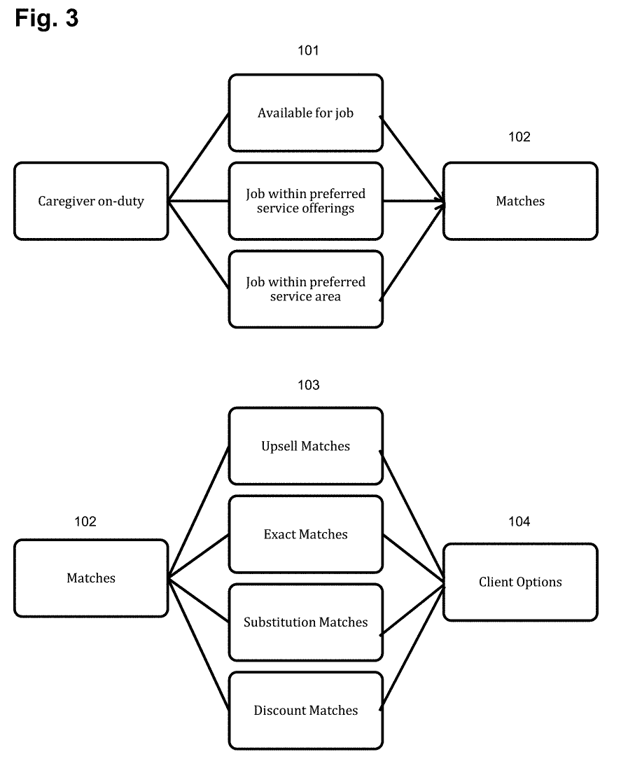

FIGS. 2-3 schematically illustrate a matching and sorting method 100 that may be performed by the system 10 for quickly enabling care to be arranged between a care client and a care resource using care resource devices 40 and a care client device 44. In accordance with the method, all of the available care resources in the sharing community are identified. Next, all of the available care resources that meet a set of minimum requirements are identified (designated by the numeral 101). The minimum requirements for a care resource include: (i) the geographic service area of the care resource includes the service location specified by the care client, (ii) the care resource is offering to perform a service specified by the care client, and (iii) the care resource is available on a specified date and time period. The care resources 101 identified as meeting the minimum requirements are included in a matched set of care resources 102. The method then applies a set of rules to the matched set of care resources 102 to sort them into four categories 103. The rules are based on preferences of the care client. These preferences may include price, experience and rating. The four categories into which the matched set of care resources 102 are sorted are: Upsell Match, Exact Match, Substitution Match, and Discount Match. The rules for one embodiment of the disclosure are described below.

The rules for the Upsell Match category as applied to each matched care resource require that the care resource's price range is above the care client's preferred price, the care resource's experience matches the care client's preferences, and the care resource's rating is at/or above the care client's preference. The rules for the Exact Match category as applied to each matched care resource require that the care resource's price range includes the care client's preferred price, the care resource's experience matches the care client's preferences, and the care resource's rating is at/or above the care client's preference. The rules for the Substitution Match category as applied to each matched care resource require that the care resource's price range includes the care client's preferred price, the care resource's experience does not match the care client's preferences and the care resource's rating is at or above the care client's preference. The rules for the Discount Match category as applied to each matched care resource require that the care resource's price range is below the care client's preferred price and one or both of: the care resource's experience does not match the client's preferences and the care resource's rating is below the care client's preference.

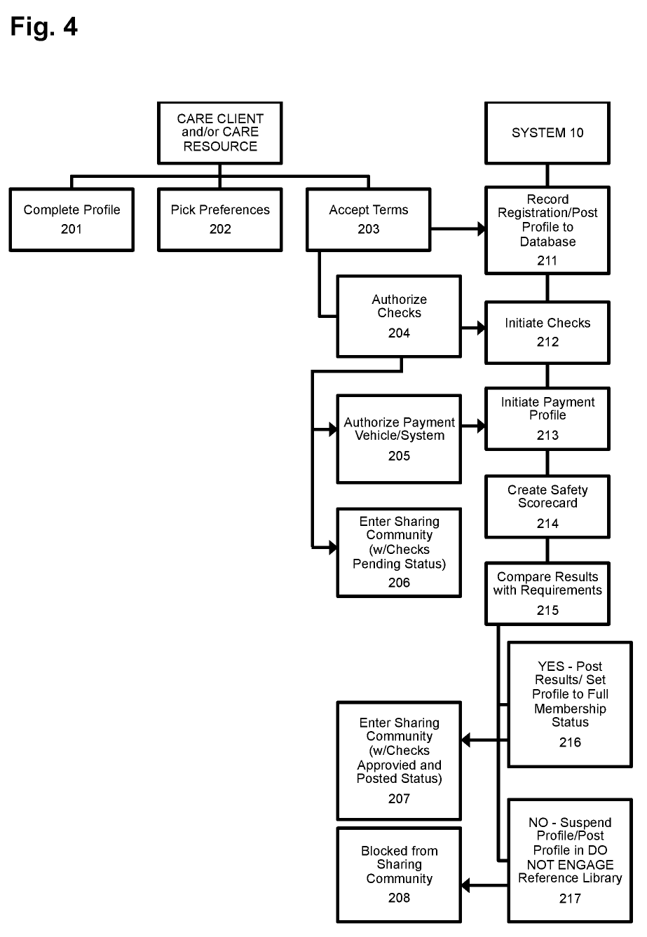

FIG. 4 schematically illustrates a method 200 for registering new care clients and new care resources (new users) with the system 10 so as to become members of the sharing community. The actions taken by a new user are performed using a care resource device 40 or a care client device 44 (as the case may be). In step 201, a new user enters their profile into the system 10. A profile includes personal data, such as name, address, telephone number and email address. For care resources, the profile will further include experience (e.g., education, work history, training, certifications, licenses, awards and commendations), services offered and the geographical area the care resource is willing to provide services within, i.e, a geographic service area. The entering of a profile also includes the creation of a unique username and password for the new user, which will enable the user to access the system 10. Typically, this occurs before any of the other profile information is entered into the system 10. In step 202, the new user enters preferences, such as rate ranges and (for care clients) preferred experience and background for care resources. In step 203, the terms and conditions governing the use of the system 10 and participation in the sharing community are displayed on a care resource device 40 or a care client device 44 (as the case may be) and presented for acceptance to the new user. The terms and conditions may also include provisions that are incorporated into each arrangement between a care client and a care resource so as to help form and define a legally binding contract between the parties. If the new user accepts the terms and conditions in step 203, the method proceeds to step 204, wherein the user is requested to provide authorization for a background check. If the user does not authorize a background check, the method stops and will not proceed any further. If, however, the user authorizes a background check, the method proceeds to steps 205 and 206. In step 205, the user is requested to provide remuneration payment/receipt vehicle information, and to authorize its use; and in step 206, the method allows the new user to use the system 10 and enter the sharing community, all on a provisional or pending basis and status. In step 205, the care client will typically provide information for one or more payment cards, i.e., credit cards and/or debit cards, while the care resource will typically provide bank deposit account information. If the new user provides authorization for a background check in step 204, the system 10 contacts, via a network (such as the Internet), one or more predetermined outside background check services and public information sources in step 212 for the new user, utilizing information from the entered profile. If the new user provides the requisite information and authorization in step 205, the system 10 starts to implement the remuneration payment/receipt vehicle in step 213. Once the method receives background information back from the one or more background check services, a background scorecard is created in step 214 and is compared with a predetermined set of requirements in step 215. If the background scorecard meets or exceeds the requirements, the new user is approved in step 216 and their profile is updated to show that they are a full member of the sharing community. The new user is notified of this positive determination in step 207. If, however, the background scorecard does not meet the requirements, the new user is rejected in step 217 and their profile is updated to show that they have been rejected and are removed from the community; their profile being stored in a library for community members use only as an added personal safety resource for engagements that may be executed outside of the community. In step 208, the new user is notified of this negative determination and is blocked from using the system 10.

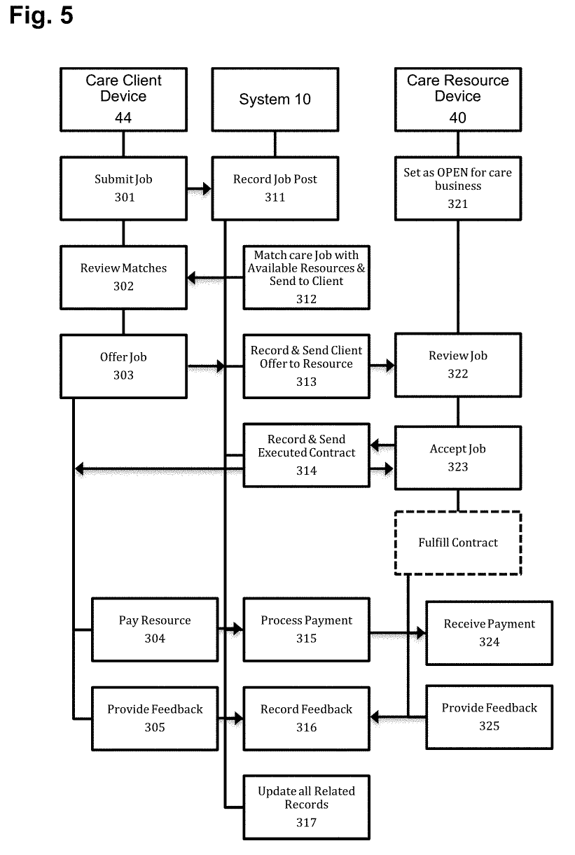

FIG. 5 schematically illustrates a method for arranging care services between parties immediately/on-demand, which may be defined as being within the next 24 or 48 hours. The system 10 facilitates the care services arrangement between care resource devices 40 and a care client device 44 through a series of user interfaces and system process steps. Through the care resource devices 40, care resources set their availability as OPEN for business in step 321. The care client submits a job through the care client device 44 in step 301. The job submittal includes a description of the job, a start time, an end time, a location and, in some embodiments, a pay rate for the job. This information is combined with the preferences and the acceptable fee rates stored in the profile database for the care client (if no pay rate is included in the job submittal) to create a job specification, which is then posted. In this regard, it should be noted that a pay rate included in the job submittal will override the acceptable fee rates stored in the profile database for the care client. In step 311, the system 10 system records the job post. In step 312, the system 10 performs the matching and sorting method 100 and sends the matched and sorted list to the care client device 44 of the care client, where it may be displayed in the graphical user interface. Through the care client device 44, the care client reviews the care resource matches in step 302 and offers the job to a selected one of the care resources in step 303. In step 313, the system 10 records the job offer and sends it to the selected care resource. Through the care resource device 40, the selected care resource reviews the job in step 322 and accepts the job in step 323. The system 10 records and shares the executed agreement with both parties in step 314. When the services begin, a timing function is initiated for calculating the duration of the services. The timing function is stopped once the services have been completed. The elapsed time calculated by the timing function is provided to a payment module 670 that automatically calculates the total cost of the services. Once the care resource has fulfilled the contract, the care client authorizes payment through the care client device 44 in step 304. In this step, the care client is given the opportunity to add a gratuity to the amount to be paid to the care resource. The system 10 processes the payment in step 315, and the selected care resource's bank account receives payment automatically in step 324 via a payment interface 900 (described below). In step 305, the care client provides feedback on the selected care resource, and in step 325, the selected care resource provides feedback on the care client. The system 10 records both sets of feedback in step 316 and updates all related records automatically in step 317.

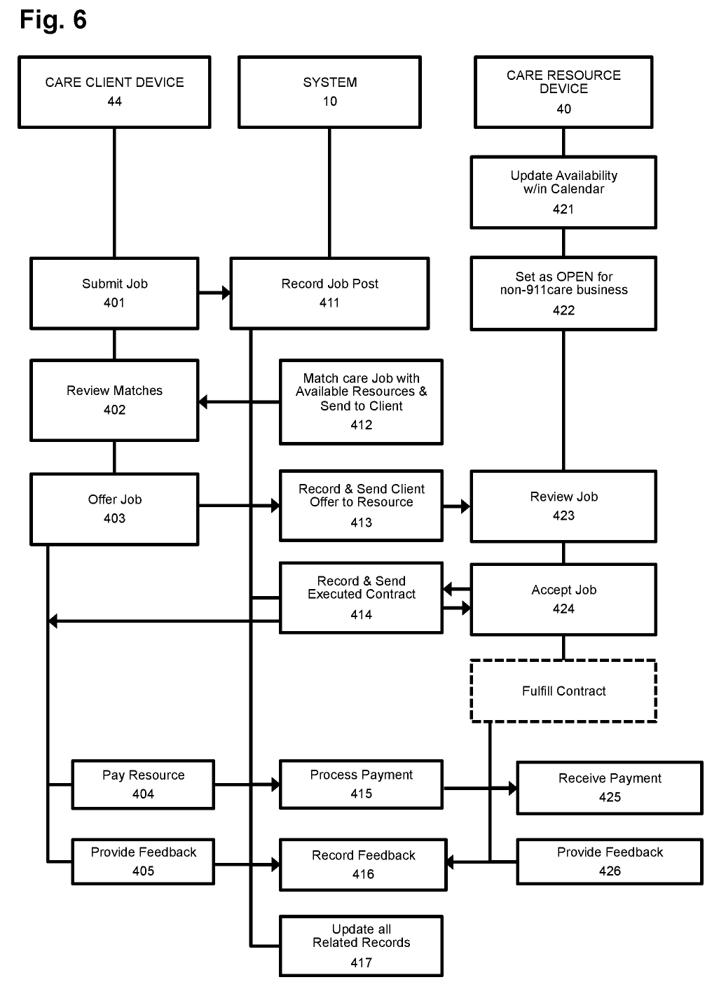

FIG. 6 schematically illustrates a method for arranging care services between parties to be scheduled in the future, e.g. more than 24 or 48 hours away. The system 10 facilitates the care services arrangement between care resource devices 40 and a care client device 44 through a series of user interfaces and system process steps. Care resources update their availability within the calendars of their care resource devices 40 in step 421 and set their their availability as OPEN for business in step 422. In step 401, the care client submits a job through their care client device 44. The job submittal includes a description of the job, a start time, an end time, a location and, in some embodiments, a pay rate for the job. This information is combined with the preferences and the acceptable fee rates stored in the profile database for the care client (if no pay rate is included in the job submittal) to create a job specification, which is then posted. In this regard, it should be noted that a pay rate included in the job submittal will override the acceptable fee rates stored in the profile database for the care client. Once the job specification is posted, the system 10 records the job post in step 411. In step 412, the system 10 performs the matching and sorting method 100 and sends the matched and sorted list to the care client device 44 of the care client, where it may be displayed in the graphical user interface. Through the care client device 44, the care client reviews the care resource matches in step 402 and offers the job to a selected one of the care resources in step 403. In step 413, the system 10 records the job offer and sends it to the selected care resource. Through a care resource device 40, the selected care resource reviews the job in step 423 and accepts the job in step 424. The system 10 records and shares the executed agreement with both parties in step 414. Since the care services are not to be performed immediately, the system 10 may periodically send the care client and the selected care resource messages (e.g., emails, texts), reminding them of the scheduled care service. When the scheduled services begin, the timing function is initiated for calculating the duration of the services. The timing function is stopped once the services have been completed. The elapsed time calculated by the timing function is provided to a payment module 670 that automatically calculates the total cost of the services. Once the selected care resource has completed the services, i.e., fulfilled the contract, the care client authorizes payment through the graphical user interface of their care client device 44 in step 404. In this step, the care client is given the opportunity to add a gratuity to the amount to be paid to the care resource. The system 10 processes the payment in step 415, and the selected care resource's bank account receives payment automatically in step 425 via a payment interface 900 (described below). In step 405, the care client provides feedback on the selected care resource, and in step 426, the selected care resource provides feedback on the care client. The system 10 records both sets of feedback in step 416 and updates all related records automatically in step 417.

The timing function described above may be initiated automatically at the scheduled start time of the services and then stopped when the care client clicks a “Job Complete” button in the graphical user interface of their care client device 44, which also initiates the payment authorization step 304 or 404. In other embodiments, the timing function may be initiated by the care client clicking a separate “Job Start” button in the graphical user interface of their care client device 44 at the start of the services. In these embodiments, the timing function may be stopped when the care client clicks a “Job Complete” button in the graphical user interface of their care client device 44, or, alternately, the timing function may be stopped when the care resource clicks a “Job Complete” button in the graphical user interface of their care resource device 40. In the embodiments where the care client starts the timing function and the care resource stops the timing function, the graphical user interface of the care client device 44 does not have a “Job Complete” button, but instead, has a “Pay Care Resource” button, which initiates the payment authorization step 304 or 404. By clicking the “Pay Care Resource” button, the care client verifies the stop of the timing function by the care resource. In still other embodiments, the care resource may both start and stop the timing function, with the care client verifying the same by clicking the “Pay Care Resource” button.

The system 10 permits a care client or a care resource to cancel an arrangement pursuant to a policy that is included in the terms and conditions that are accepted by users in step 203 of the process 200. Pursuant to this policy, both a care client and a care resource may cancel an arrangement (with notice to the other party) outside of 24 hours from the scheduled performance date and time with no penalty. If a care client or a care resource cancels an arrangement (with notice to the other party) within 24 hours of the scheduled date and time, they must pay 20% of the projected fees for the arrangement as a penalty to the other party. If a care client or a care resource fails to show up for an arrangement (without notice), the 20% penalty is imposed on them and they are given a warning. After three warnings, a care client or a care resource may be ejected from the sharing community and their access to the system 10 terminated.

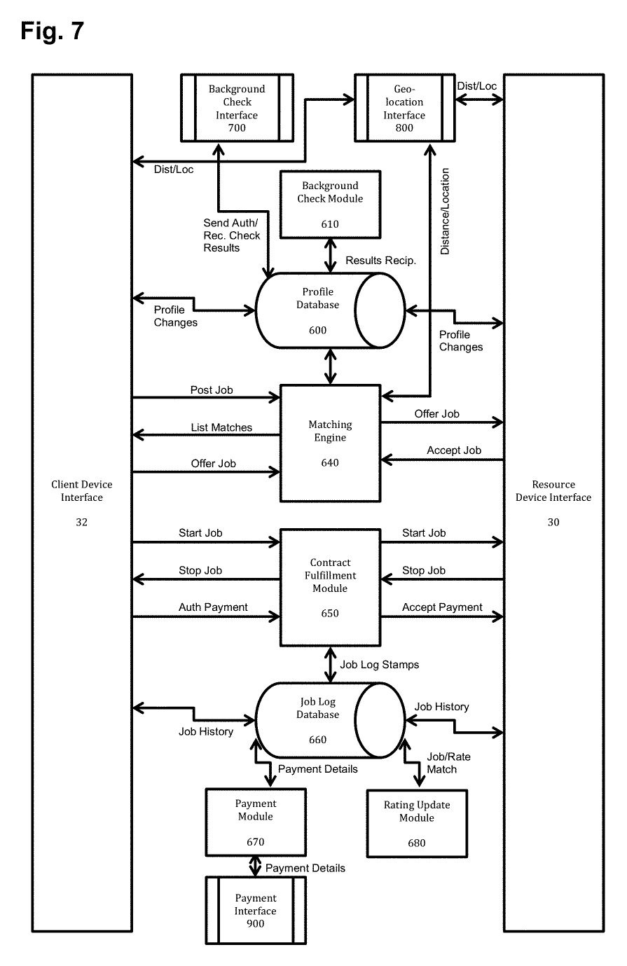

FIG. 7 provides further details of the system 10. However, the platform 12 is not shown for purposes of better illustrating the other components of the system 10. The system 10 further includes a profile database 600 connected to the client device interface 32 and the resource device interface 30. The profile database 600 collects, via the client device interface 32, profile information entered by care clients through their care client devices 44. In addition, the profile database 600 collects, via the resource device interface 30, profile information entered by care resources through their care resource devices 40. Through a set of predetermined background check application program interface (API) protocols 700, the profile database 600 also garners and stores related background check results performed on care clients and care resources. Similarly, through a set of predetermined payment API protocols 900, the profile database 600 initiates the creation of client payment facilities and resource receipt facilities. The profile database 600 provides the background check results to a background check module 610, which performs a process that creates background scorecards from the check results. The module 610 shares the background scorecards with the profile database 600, which updates the profiles of the care clients and the care resources with their background scorecards, respectively. The profile database 600 also provides the background scorecards to the care resources and the care clients, via their devices 40, 44 and the interfaces 30, 32, respectively. The client device interface 32 provides the necessary logic to facilitate care client profile information changes with the profile database 600, which automatically saves change records and updates all relevant records within the system. Similarly, the resource device interface 30 provides the necessary logic to facilitate care resource profile information changes with the profile database 600, which saves change records and automatically updates all relevant records within the system.

The system 10 also includes a matching engine 640 that performs the matching and sorting method 100 described above, wherein the requirements of a care client are matched with offerings of care resources and thereafter sorted into categories. The client device interface 32 provides the necessary logic to interface with the matching engine 640 to facilitate job posting, resource reviewing, and job offering orchestrated by the matching engine 640. Similarly, the resource device interface 30 provides the necessary logic to interface with the matching engine 640 to facilitate the job reviewing and job accepting orchestrated by the matching engine 640. The matching engine 640, through a set of predetermined geo-location API protocols 800, garners and shares map and location information for and with the relevant parties. The client device interface 32 provides the necessary logic to stamp the start of a job (or receive a job start stamp), stamp the stop of a job (or receive a job stop stamp), and authorize payment, all of which is orchestrated by a contract fulfillment module 650. Similarly, the resource device interface 30 provides the necessary logic to receive a job start stamp (or stamp the start of a job), receive a job stop stamp (or stamp the stop of a job), and accept payment, all of which are orchestrated by the contract fulfillment module 650. The contract fulfillment module 650 continually updates a job log database 660 with all job log stamps and related authorizations. The contract fulfillment module 650 also maintains a calendar schedule of all jobs that have been logged. The job log database 660 continually saves and shares job history information updates with all relevant records within the system 10, including feedback and recalculated ratings provided by a rating update module 680. The job log database 660, when provided with a complete set of job log stamps, automatically communicates all relevant information to initiate a payment method performed by a payment module 670. The payment module 670 calculates and communicates the disbursement amounts to a payment interface 900 through a set of predetermined payment API protocols, which triggers all related payments. The payment interface 900 communicates with an E-Commerce payment gateway, such as PayPal, Stripe or BrainTree, which directly transfers the funds from the care client's payment card into the care resource's bank account.

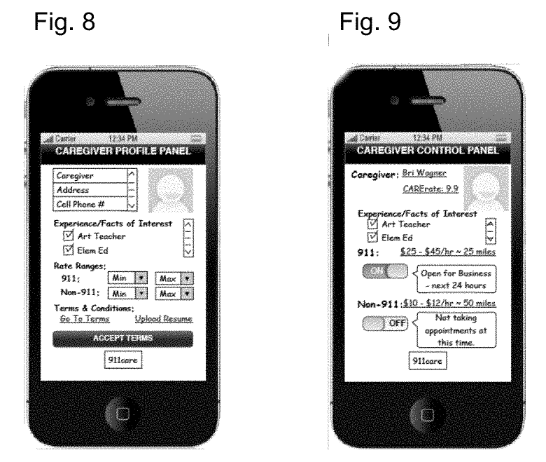

As set forth above, care resources and care clients communicate with the system 10 through graphical user interfaces on their care resource devices 40 and care client devices 44, respectively. Some of the screens or panels of the graphical user interfaces are shown in FIGS. 8-15. In these panels, care services that are provided immediately/on-demand may be referred to as “911”, while care services that are scheduled in the future may be referred to as “non-911”. In addition, a care resource may be referred to as a “caregiver” and a care client may be referred to as a “customer”.

FIG. 8 shows a care resource profile panel that may be displayed on a care resource device 40, wherein the profile panel facilitates the entry of the care resource's profile, i.e., the collection of information on the care resource, including the address, phone number, work experience, service rates, and photograph(s) of the care resource.

FIG. 9 shows a care resource control panel that may be displayed on a care resource device 40, wherein the control panel permits the care resource to set and change their availability and related preferences for on-demand care services and scheduled care services, in real-time. The control panel also provides the ability for the care resource to access their profile, and access feedback status and community rating.

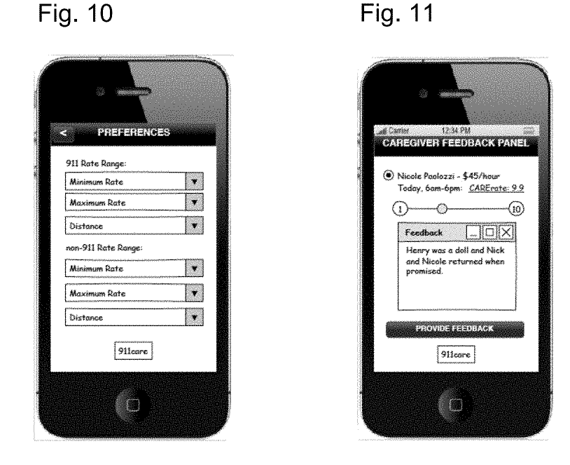

FIG. 10 shows a care resource preference panel that may be displayed on a care resource device 40, wherein the care resource may set their rate ranges (minimum and maximum rates) and service areas (distances) for on-demand care services and scheduled care services, in real time. This feature permits different rate ranges and different distances to be posted for on-demand care services and schedule care services, respectively. This is shown, for example, in FIG. 9, wherein a caregiver (care resource) is shown to have a rate range of $25 to $45 per hour and a travel range of 25 miles for on-demand care services, whereas the caregiver (care resource) has a rate range of $10 to $12 per hour and a travel range of 50 miles for scheduled care services. This reflects a payment premium for on-demand care services.

FIG. 11 shows a care resource feedback panel that may be displayed on a care resource device 40, wherein the feedback panel permits a care resource to quickly rate and provide feedback on a care client and a job they just completed. This information is provided to the system 10, which uses the information to automatically update the profiles of both the care client and the care resource. The aggregate rating of the care client is also updated to include the rating made by the care resource.

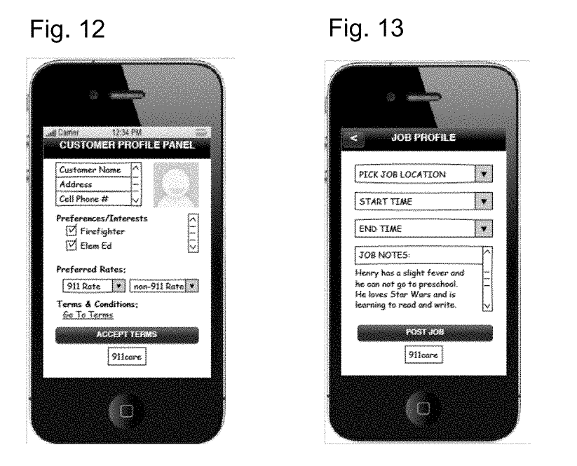

FIG. 12 shows a care client profile panel that may be displayed on a care client device 44, wherein the profile panel facilitates the entry of the care client's profile, i.e., the collection of information on the care client, including the address, phone number and photograph(s) of the care client. In addition, the profile panel permits a care client to enter preferences for prospective care resources, such as preferred backgrounds for care resources and preferred rates for on-demand care services and scheduled care services, respectively.

FIG. 13 shows a job profile panel that may be displayed on a care client device 44, wherein the job profile panel permits a care client to quickly create and post a job. The information that a care client may use to create a profile for the job include location, start time, end time and notes on the job.

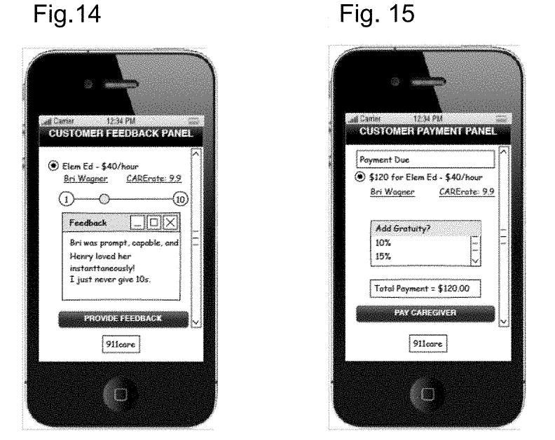

FIG. 14 shows a care client feedback panel that may be displayed on a care client device 44, wherein the feedback panel permits a care client to quickly rate and provide feedback on a care resource and a job they just completed.

FIG. 15 shows a care client payment panel that may be displayed on a care client device 44, wherein the payment panel permits a care client to quickly authorize payment to a care resource for the job they just completed. The system 10 gives the care client the opportunity to add a gratuity to the amount to be paid to the care resource.

Embodiments within the scope of the present disclosure may include tangible and/or non-transitory computer-readable storage media for carrying or having computer-executable instructions or data structures stored thereon. Such non-transitory computer-readable storage media may be any available media that can be accessed by a general purpose or special purpose computer. Non-limiting examples may include: RAM, ROM, EEPROM, flash memory or other memory, CD-ROM, DVD or other optical disk storage, magnetic disk storage or other magnetic storage devices, or any other medium which can be used to carry or store desired information (e.g., program code means in the form of computer-executable instructions, data structures, or processor chip design). When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions may include, for example, instructions and data which cause a general purpose computer, special purpose computer, or special purpose processing device to perform a function or group of functions. Computer-executable instructions may also include program modules that are executed by computers in stand-alone or network environments. In general, program modules may include routines, programs, components, data structures, objects, and the functions inherent in the design of special-purpose processors, etc. that perform particular tasks or implement particular abstract data types. Computer-executable instructions, associated data structures, and program modules may represent examples of the program code means for executing steps of the methods disclosed herein. A particular sequence of such executable instructions or associated data structures represents examples of corresponding acts for implementing the functions described in such steps

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A method for arranging and overseeing the provision of care services between care clients and care resources in a peer-to-peer services marketplace computer system, the method comprising:
providing a profile database storing information about the care clients and the care resources, the information stored about the care resources including availability, services being offered, geographic service area, experience, offered fee ranges and ratings, the information stored about the care clients including preferences for care resources, the preferences including preferred fee rates, preferred experience and preferred ratings;
receiving a care service request message from a care client via a first communication device, the care service request message including a description of a requested service, a date and time period for performance of the requested service and a location where the requested service is to be performed;
retrieving the preferences of the care client from the profile database;
creating a job specification from the care service request message and the retrieved preferences of the care client, the job specification including the care client's preferred fee rate, the care client's preferred experience and the care client's preferred rating;
retrieving information about care resources from the profile database;
comparing the job specification with the retrieved information about care resources to identify care resources who meet predetermined minimum requirements of the job specification;
applying rules to the job specification and the retrieved information for the identified care resources to sort the identified care resources into categories comprising exact match, upsell match, substitution match and discount match;
wherein the rules for the exact match category as applied to each identified care resource require that the offered fee range of the identified care resource includes the care client's preferred fee rate, the experience of the identified care resource matches the care client's preferred experience and the rating of the identified care resource is at or above the care client's preferred rating;
wherein the rules for the upsell match category as applied to each identified care resource require that the offered fee range of the identified care resource is above the care client's preferred fee rate, the experience of the identified care resource matches the care client's preferred experience and the rating of the identified care resource is at or above the care client's preferred rating;
wherein the rules for the substitution match category as applied to each identified care resource require that the offered fee range of the identified care resource includes the care client's preferred fee rate, the experience of the identified care resource does not match the care client's preferred experience and the rating of the identified care resource is at or above the care client's preferred rating;
wherein the rules for the discount match category as applied to each identified care resource require that the offered fee range of the identified care resource is below the care client's preferred fee rate and one or both of: the experience of the identified care resource does not match the care client's preferred experience and the rating of the identified care resource is below the care client's preferred rating;
transmitting a message containing the sorted identified care resources to the first communication device;
receiving a selection message from the first communication device, indicating a selection of one of the sorted identified care resources;
sending an offer message to a second communication device of the selected care resource;
receiving an acceptance message from the second communication device of the selected care resource; and
sending a notification-of-acceptance message to the first communication device.

2. The method of claim 1, wherein the predetermined minimum requirements include: the service being offered by the care resource matches the requested service, the care resource is available to perform the requested service on the date and for the time period requested by the care client and the geographic service area of the care resource includes the location where the requested service is to be performed.

3. The method of claim 1, further comprising:
receiving a start message that the performance of the requested service has started;
receiving a stop message that the performance of the requested service has stopped;
measuring the elapsed time between the receipt of the start and stop messages; and
using the elapsed time as a performance time for the requested service.

4. The method of claim 3, wherein start message is received from the care client via the first communication device and the stop message is received from the care resource via the second communication device.

5. The method of claim 3, wherein the start message is received from a calendar schedule and the stop message is received from the care client via the first communication device.

6. The method of claim 3, further comprising:
multiplying the preferred fee rate by the performance time to produce a service fee for the requested service; and
effecting payment of the service fee to the care resource.

7. The method of claim 6, wherein the step of effecting payment comprises:
communicating a payment request to an external payment service, the payment request including the service fee and other payment information, wherein the payment request enables the payment service to process a payment of the service fee to the care resource.

8. The method of claim 1, further comprising:
receiving a review of the care resource from the care client via the first communication device.

9. The method of claim 8, further comprising:
retrieving the rating of the care resource from the profile database;
modifying the retrieved rating using the received review of the care resource; and
replacing the rating of the care resource stored in the profile database with the modified retrieved rating.

10. The method of claim 9, further comprising:
receiving a review of the care client from the care resource via the second communication device.

11. The method of claim 10, wherein the information stored about the care clients in the profile database includes ratings of the care clients, and wherein the method further comprises:
retrieving the rating of the care client from the profile database;
modifying the retrieved rating using the received review of the care client; and
replacing the rating of the care client stored in the profile database with the modified retrieved rating.

12. The method of claim 1, further comprising:
performing background checks on the care resource and the care client.

13. The method of claim 1, wherein the care service request message further includes a preferred fee rate for the requested service, and wherein the care client preferred fee rate in the job specification is taken from the care service request message.

14. The non-transitory computer readable medium of claim 1, wherein the requested service is selected from the group consisting of healthcare, eldercare, childcare, personal training and fitness, hair styling, barber services, counseling, physical therapy, occupational therapy, veterinary services and culinary services.

15. A non-transitory computer readable medium comprising computer-executable instructions which, when executed by a processor, perform a method of arranging and overseeing the provision of care services between care clients and care resources, the method comprising:
providing a profile database storing information about the care clients and the care resources, the information stored about the care resources including availability, services being offered, geographic service area, experience, offered fee ranges and ratings, the information stored about the care clients including preferences for care resources, the preferences including preferred fee rates, preferred experience and preferred ratings;
receiving a care service request message from a care client via a first communication device, the care service request message including a description of a requested service, a date and time period for performance of the requested service and a location where the requested service is to be performed;
retrieving the preferences of the care client from the profile database;
creating a job specification from the care service request message and the retrieved preferences of the care client, the job specification including the care client's preferred fee rate, the care client's preferred experience and the care client's preferred rating;
retrieving information about care resources from the profile database;
comparing the job specification with the retrieved information about care resources to identify care resources who meet predetermined minimum requirements of the job specification;
applying rules to the job specification and the retrieved information for the identified care resources to sort the identified care resources into categories comprising exact match, upsell match, substitution match and discount match;
wherein the rules for the exact match category as applied to each identified care resource require that the offered fee range of the identified care resource includes the care client's preferred fee rate, the experience of the identified care resource matches the care client's preferred experience and the rating of the identified care resource is at or above the care client's preferred rating;
wherein the rules for the upsell match category as applied to each identified care resource require that the offered fee range of the identified care resource is above the care client's preferred fee rate, the experience of the identified care resource matches the care client's preferred experience and the rating of the identified care resource is at or above the care client's preferred rating;
wherein the rules for the substitution match category as applied to each identified care resource require that the offered fee range of the identified care resource includes the care client's preferred fee rate, the experience of the identified care resource does not match the care client's preferred experience and the rating of the identified care resource is at or above the care client's preferred rating;
wherein the rules for the discount match category as applied to each identified care resource require that the offered fee range of the identified care resource is below the care client's preferred fee rate and one or both of: the experience of the identified care resource does not match the care client's preferred experience and the rating of the identified care resource is below the care client's preferred rating;
transmitting a message containing the sorted identified care resources to the first communication device;
receiving a selection message from the first communication device, indicating a selection of one of the sorted identified care resources;
sending an offer message to a second communication device of the selected care resource;
receiving an acceptance message from the second communication device of the selected care resource; and
sending a notification-of-acceptance message to the first communication device.

16. The non-transitory computer readable medium of claim 15, wherein the predetermined minimum requirements include: the service being offered by the care resource matches the requested service, the care resource is available to perform the requested service on the date and for the time period requested by the care client and the geographic service area of the care resource includes the location where the requested service is to be performed.

17. The non-transitory computer readable medium of claim 15, wherein the method further comprises:
receiving a start message that the performance of the requested service has started;
receiving a stop message that the performance of the requested service has stopped;
measuring the elapsed time between the receipt of the start and stop messages; and
using the elapsed time as a performance time for the requested service.

18. The non-transitory computer readable medium of claim 17, wherein the method further comprises:
multiplying the preferred fee rate by the performance time to produce a service fee for the requested service; and
effecting payment of the service fee to the care resource.

19. The non-transitory computer readable medium of claim 15, wherein the method further comprises:
receiving a review of the care resource from the care client via the first communication device; and
receiving a review of the care client from the care resource via the second communication device.

20. The non-transitory computer readable medium of claim 15, wherein the method further comprises:
performing background checks on the care resource and the care client.
